(19) United States
(12) Patent Application Publication
(10) Pub. No.: US 2005/0247794 A1
(43) Pub. Date: Nov. 10, 2005

(54) Identification document having intrusion resistance

(76) Inventors: Robert L. Jones, Andover, MA (US); Daoshen Bi, Boxborough, MA (US); Tung-Feng Yeh, Waltham, MA (US)

Correspondence Address: DIGIMARC CORPORATION, 9405 SW GEMINI DRIVE, BEAVERTON, OR, 97008, US

(21) Appl. No.: 11/092,136

(22) Filed: Mar. 28, 2005

Related U.S. Application Data
(60) Provisional application No. 60/558,177, filed on Mar. 26, 2004.

(51) Int. Cl. G06K 19/00; G06K 19/02

(52) U.S. Cl. 235/487; 235/488

(57) ABSTRACT

An identification document is provided, comprising a core layer, such as TESLIN, laminated directly to a laminate layer, such as polycarbonate, without the use of an adhesive. The core layer has at least one indicium formed thereon and has a first surface. The first layer of laminate is affixed to the core layer by a press lamination process where the press lamination process is sufficient to couple the core layer to the first layer such that an attempt to separate the first layer from the core layer causes at least a partial destruction of the core layer.

### RELATED APPLICATION DATA

The present application claims benefit of U.S. Patent application 60/558,177, filed Mar. 26, 2004, which is hereby incorporated by reference.

The present application is also related to the following U.S. patents and patent applications, each of which is hereby incorporated by reference:
Document Laminate Formed From Different Polyester Materials (application Ser. No. 10/692,463, Attorney docket Number P0901D, filed Oct. 21, 2003, Inventor Brian Labrec);
Optically Variable Security Features Having Covert Forensic Features (application Ser. No. 10/673,048, Attorney Docket No. P0890D, filed Sep. 26, 2003, Inventors Robert Jones and Daoshen Bi);
Identification Document (Application No. 60/471,429, Attorney Docket No. P0833D, filed May 16, 2003, inventors Robert Jones, Brian Labrec, Daoshen Bi, and Thomas Regan);
Use of Pearlescent and Other Pigments to Create Security Documents (application Ser. No. 09/969,200, Attorney Docket No. P0537D, Inventors Bentley Bloomberg and Robert L. Jones, filed Oct. 2, 2001, now U.S. Pat. No. 6,827,277);
Identification Card Printed With Jet Inks and Systems and Methods of Making Same (application Ser. No. 10/289,962, Attorney Docket No. P0708D, Publication No. 2003-0211296;
Contact Smart Cards Having a Document Core, Contactless Smart Cards Including Multi-Layered Structure, PET-Based Identification Document, and Methods of Making Same (application Ser. No. 10/329,318, Attorney Docket No. P0711D, filed Dec. 23, 2002—Inventors Robert Jones, Joseph Anderson, Daoshen Bi, Thomas Regan, and Dennis Mailloux, now U.S. Pat. No. 6,843,422);
Ink with Cohesive Failure and Identification Document Including Same (application Ser. No. 10/329,315, Attorney Docket No. P0714D, filed Dec. 23, 2002—Inventors Robert Jones and Bentley Bloomberg, Publication No. 2003-0226897);
Laser Engraving Methods and Compositions, and Articles Having Laser Engraving Thereon (application Ser. No. 10/326,886, Attorney Docket No. P0724D, filed Dec. 20, 2002—Inventors Brian Labrec and Robert Jones, Publication No. 2003-0234286);
Multiple Image. Security Features for Identification Documents and Methods of Making Same (application Ser. No. 10/325,434, Attorney Docket No. P0728D, filed Dec. 18, 2002—Inventors Brian Labrec, Joseph Anderson, Robert Jones, and Danielle Batey, now U.S. Pat. No. 6,817,530);
Optically Variable Devices with Embedded Data for Authentication of Identification Documents (Application No. 60/459,284, Attorney Docket No. P0816D, filed Mar. 31, 2003—Inventor Robert Jones); and
Optically Variable Devices with Encrypted Embedded Data for Authentication of Identification Documents (Application No. 60/463,659, Attorney Docket No. P0825D, filed Apr. 16, 2003—Inventors Robert Jones and Leo Kenen)..

Each of the above U.S. patent documents is herein incorporated by reference in its entirety. The present invention is also related to U.S. patent application Ser. No. 09/747,735, filed Dec. 22, 2000, Ser. No. 09/602,313, filed Jun. 23, 2000, now U.S. Pat. No. 6,752,432, and Ser. No. 10/094,593, filed Mar. 6, 2002, Publication No. 2002-0170966, U.S. Provisional Patent Application No. 60/358,321, filed Feb. 19, 2002, as well as U.S. Pat. No. 6,066,594. Each of the above U.S. patent documents is herein incorporated by reference in its entirety.

### TECHNICAL FIELD

The present invention generally relates to identification and security documents, and in particular, relates to the manufacture of such identification documents. In particular, this invention relates to manufacturing identification documents having resistance to intrusion, providing visible evidence of intrusion, and/or which are difficult to alter or tamper with because of the visible evidence of intrusion.

### BACKGROUND AND SUMMARY

Identification Documents

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening and prior to boarding their flight. In addition, because we live in an ever-evolving cashless society, ID documents are used to make payments, access an automated teller machine (ATM), debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

As those skilled in the art know, ID documents such as drivers licenses can contain information such as a photographic image, a bar code (which may contain information specific to the person whose image appears in the photographic image, and/or information that is the same from ID document to ID document), variable personal information, such as an address, signature, and/or birthdate, biometric information associated with the person whose image appears in the photographic image (e.g., a fingerprint), a magnetic stripe (which, for example, can be on the a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

An exemplary ID document can comprise a substrate or core layer (which can be pre-printed), such as a light-colored, opaque material (e.g., polycarbonate, TESLIN (available from PPG Industries) polyvinyl chloride (PVC) material, etc). In certain instances and with certain printing or information forming technologies, variable or personalized data can be formed directly on the substrate or core layer. In other instances, the core layer may be coated and/or laminated with another material to enable printing or other methods of forming information. For example, the substrate or core layer can be laminated with a transparent material, such as clear polycarbonate or PVC to form a so-called “card blank”.

Information, such as variable personal information (e.g., photographic information), can then formed on the card blank using one or more methods, such as laser xerography, Indigo, intaglio, laser engraving or marking, inkjet printing, thermal or mass transfer printing, dye diffusion thermal transfer (“D2T2”) printing, (described in commonly assigned U.S. Pat. No. 6,066,594, which is incorporated herein by reference in its entirety.), etc. The information can, for example, comprise an indicium or indicia, such as the invariant or nonvarying information common to a large number of identification documents, for example the name and logo of the organization issuing the documents. The information may be formed by any known process capable of forming the indicium on the specific core material used.

Certain technologies for forming or printing information may require further protection of the information, so an additional layer of transparent overlaminate can be coupled to the core layer or card blank and the information printed thereon, as is known by those skilled in the art. Illustrative examples of usable materials for overlaminates include polycarbonate, biaxially oriented polyester, or other optically clear durable plastic film.

In the production of images useful in the field of identification documentation, it may be desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16 1993 to J. W. Luening, et al. All of the aforementioned documents are hereby incorporated by reference.

Identification documents of the types mentioned above can take a number of forms, depending on cost and desired features. For example, some ID documents comprise highly plasticized poly(vinyl chloride) or have a composite structure with polyester laminated to 0.5-2.0 mil (13-51 mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 mum), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

One response to the problem of counterfeiting ID documents has involved the integration of verification features that are difficult to copy by hand or by machine, or which are manufactured using secure and/or difficult to obtain materials. One such verification feature is the use in the card of a signature of the card's issuer or bearer. Other verification features have involved, for example, the use of watermarks, biometric information, microprinting, covert materials or media (e.g., ultraviolet (UV) inks, infrared (IR) inks, fluorescent materials, phosphorescent materials), optically varying images, fine line details, validation patterns or marking, and polarizing stripes. These verification features are integrated into an identification card in various ways, as appreciated by those skilled in the art, and they may be visible or invisible (covert) in the finished card. If invisible, they can be detected by viewing the feature under conditions which render it visible. At least some of the verification features discussed above have been employed to help prevent and/or discourage counterfeiting.

Manufacture and Printing Environments

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

In contrast, a CI assembling process is more of a bulk process facility, where many cards are produced in a centralized facility, one after another. (For example, picture a setting where a driver passes a driving test, but then receives her license in the mail from a CI facility a short time later. The CI facility may process thousands of cards in a continuous manner.).

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

Further information about illustrative central issue processes can be found in a commonly assigned patent application entitled “Multiple Image Security Features for Identification Documents and Methods of Making Same”, Ser. No. 10/325,434, published as U.S. patent publication No. 20030183695 on Oct. 2, 2003, the contents of which are hereby incorporated by reference.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document. It will be appreciated that an OTC card issuing process is by its nature can be an intermittent—in comparison to a continuous—process.

OTC identification documents of the types mentioned above can take a number of forms, depending on cost and desired features. Some OTC ID documents comprise highly plasticized poly(vinyl chloride) or have a composite structure with polyester laminated to 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

Digital OTC identification documents of the types mentioned above are generally comprised of highly plasticized poly(vinyl chloride) or have a composite structure with polyester laminated to highly plasticized 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 mu.m) overlay patches applied at the printhead, holographic hot stamp foils (0.125-0.250 mil 3-6 .mu.m), or a clear polyester laminate (0.5-10 mil, 13-254 .mu.m) supporting common security features; these last two types of protective foil or laminate are applied at a laminating station separate from the printhead. The choice of laminate dictates the degree of durability and security imparted to the system in protecting the image and other data.

One type of OTC identification document, available from the assignee of the present invention is the card structure described in commonly assigned U.S. Pat. No. 6,066,594, and the contents of this patent are incorporated hereto by reference in their entirety.

OTC identification documents can be printed in a number of ways, including by mass-transfer printing, dye diffusion thermal transfer (D2T2) printing, ink jet printing, etc. The reader is presumed to be familiar with such printing methods.

Intrusion into ID documents

One issue that always remains with identification documents is counterfeiting, alteration, and tampering with identification documents. The ID document counterfeiter remains surprisingly resourceful. Improvements are needed to stay ahead of the counterfeiter. One counterfeiting technique involves a de-lamination attack, Consider an ID document that includes a printed substrate covered by a laminate layer. A de-lamination attack removes the laminate layer, sometimes with the aid of heat and/or a solvent, to access information printed on the substrate. Once revealed, the counterfeiter can alter the printed information and reuse the substrate or laminate.

Some ID documents are susceptible to this type of attack.. Consider the ID document including a substrate, ink applied to the substrate (or laminate layer) to convey information and a laminate layer covering the ink and substrate. Some conventional inks generally include a strong adhesion to either a document substrate or to a laminate. A counterfeiter can use this design characteristic (adhesion) to his advantage. Upon de-lamination, the ink may adhere to the substrate layer or to a laminate layer. Regardless, in some instances, the printed information is typically preserved on at least one layer and may be used again. (For example, if the ink adheres to a laminate, the counterfeiter can reuse the laminate. Or if the ink adheres to the substrate, the counterfeiter can perhaps alter the information by applying additional ink, or simply reuse the remaining information on the substrate.).

U.S. Pat. No. 5,380,695, herein incorporated by reference, discloses an identification document designed to help deter intrusion attempts. This patent describes an image-receiving element that includes a support, a polymeric security layer including printing, and an image-receiving layer. The polymeric security layer is designed such that its cohesivity is less than its adhesivity for each layer that is contiguous thereto. A printed security pattern is hopefully destroyed through partitioning of the security layer during an attempted de-lamination of the image-receiving layer from the image-receiving element.

It would be further desirable to be able to readily detect whether such tampering and/or a forgery has occurred with respect to an identification document and/or any indicia on it. For example, because variable indicia (e.g., a birth date) is a frequent target of alteration and/or other types of fraud, it would be desirable if an identification document could be constructed such that attempted tampering would destroy or damage the variable and/or fixed data, and/or other ID document layers, such as the core layer, in such a way that re-assembly is extremely difficult and alterations (and/or the attempt at intrusion) would be detectable.

We have discovered systems and methods for creating identification documents that can be very resistant to such attempts at intrusion. We have also discovered identification document architectures and manufacturing methods that can help make attempted intrusions, tampering, and/or forgery more readily apparent to a naked eye. In addition, we have found that our systems and methods can, in at least some embodiments, create identification documents without requiring the use of adhesives (adhesives can be a “weak point” for permitting intrusion). The systems, methods, and architectures we have developed can be adapted to both CI and OTC identification document manufacturing environments. We have found that various embodiments of the invention can be particularly useful and advantageous in certain CI manufacturing environments.

In one embodiment, we provide an identification document comprising a core layer, such as TESLIN, laminated directly to a laminate layer, such as polycarbonate, without the use of an adhesive. The core layer has at least one indicium formed thereon and has a first surface. The first layer of laminate is affixed to the core layer by a press lamination process where the press lamination process is sufficient to couple the core layer to the first layer such that an attempt to separate the first layer from the core layer causes at least a partial destruction of the core layer.

The indicium can be formed by many different methods, including at least one of Indigo, laser xerography, inkjet, D2T2, offset, lithography, thermal transfer, and laser engraving. To improve laser engraving, the laminate layer can further comprise a laser sensitizing material, such as the laser enhancing additive described in U.S. patent application Ser. No. 10/326,886 (which application is described elsewhere herein and incorporated by reference).

In one embodiment, the core layer is laminated to the first layer of laminate by a press lamination process wherein the a lamination temperature is between 310 and 350 degrees F., the lamination pressure is between 5000-15,000 pounds per square meter (PSM), and the lamination time is between 5-10 minutes.

In one embodiment, the core layer is laminated to the first layer of laminate by a press lamination process wherein the lamination temperature is about 340 degrees F., the pressure is about 10,000 PSM, and the lamination time is about 7 minutes.

The foregoing and other features and advantages of the present invention will be even more readily apparent from the following Detailed Description, which proceeds with reference to the accompanying drawings and the claims.

### BRIEF DESCRIPTION OF THE DRAWINGS

The advantages, features, and aspects of embodiments of the invention will be more fully understood in conjunction with the following detailed description and accompanying drawings, wherein:

FIG. 1 is an illustration of an identification document in accordance with a first embodiment of the invention;

FIG. 2 is a cross section of the identification document of FIG. 1, taken along the A-A line;

FIG. 3 is a flow chart of a first process for manufacturing identification cards, in accordance with one embodiment of the invention;

FIG. 4 is an illustrative diagram of a central issue card production system that can be used to produce the identification documents in accordance with at least some embodiments of the invention;

FIG. 5 is a cross sectional view of the identification document of FIG. 1, showing a path of breakage during an attempted intrusion;

FIG. 6 is a cross-sectional view of the identification document of FIG. 5, showing breakage of the core after intrusion;

FIG. 7 is a cross-sectional view of an identification document in accordance with a fourth embodiment if the invention, showing breakage of the core, including failure of personalized data, during intrusion;

FIG. 8 is a cross-sectional view of an identification document in accordance with a fifth embodiment if the invention, showing breakage of the core, including failure of personalized data, during intrusion;

FIG. 9 is a cross sectional of an identification document in accordance with a second embodiment of the invention;

FIG. 10 is a cross sectional of an identification document in accordance with a third embodiment of the invention; and

FIG. 11 is a flow chart of a second process for manufacturing identification cards, in accordance with one embodiment of the invention.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION

Terminology

In the foregoing discussion, the use of the word “ID document” is broadly defined and intended to include all types of ID documents, including (but not limited to), documents, magnetic disks, credit cards, bank cards, phone cards, stored value cards, debit cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, welfare cards, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, traveler's cards, restaurant cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue.

In addition, in the foregoing discussion, “identification” at least refers to the use of an ID document to provide identification and/or authentication of a user and/or the ID document itself. For example, in a conventional driver's license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one embodiment of the invention, can include covert images that, when viewed using the proper facilitator (e.g., an appropriate light or temperature source), provide a discernable image that is usable for identification or authentication purposes.

Of course, it is appreciated that certain images may be considered to be “identification quality” if the images are machine readable or recognizable, even if such images do not appear to be “identification quality” to a human eye, whether or not the human eye is assisted by a particular piece of equipment, such as a special light source. For example, in at least one embodiment of the invention, an image or data on an ID document can be considered to be “identification quality” if it has embedded in it machine-readable information (such as digital watermarks or steganographic information) that also facilitate identification and/or authentication.

Further, in at least some embodiments, “identification” and “authentication” are intended to include (in addition to the conventional meanings of these words), functions such as recognition, information, decoration, and any other purpose for which an indicia can be placed upon an article in the article's raw, partially prepared, or final state. Also, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

“Personalization”, “Personalized data” and “variable” data are used interchangeably herein, and refer at least to data, images, and information that are “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some embodiments of the invention, personal/variable data can include some fixed data, as well. For example, in at least some embodiments, personalized data refers to any data that is not pre-printed onto an ID document in advance, so such personalized data can include both data that is cardholder-specific and data that is common to many cardholders. Variable data can, for example, be printed on an information-bearing layer of the ID card using thermal printing ribbons and thermal printheads.

The terms “indicium” and indicia as used herein cover not only markings suitable for human reading, but also markings intended for machine reading. Especially when intended for machine reading, such an indicium need not be visible to the human eye, but may be in the form of a marking visible only under infra-red, ultra-violet or other non-visible radiation. Thus, in at least some embodiments of the invention, an indicium formed on any layer in an identification document (e.g., the core layer) may be partially or wholly in the form of a marking visible only under non-visible radiation. Markings comprising, for example, a visible “dummy” image superposed over a non-visible “real” image intended to be machine read may also be used.

“Laminate” and “overlaminate” include (but are not limited to) film and sheet products. Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. However, transparency is not required. Examples of usable laminates include at least polyester, polycarbonate, polystyrene, cellulose ester, polyolefin, polysulfone, or polyamide. Laminates can be made using either an amorphous or biaxially oriented polymer as well. The laminate can comprise a plurality of separate laminate layers, for example a boundary layer and/or a film layer. Of course, the types and structures of the laminates described herein are provided only by way of example, those skilled in the art will appreciated that many different types of laminates are usable in accordance with the invention.

The material(s) from which a laminate is made may be transparent, but need not be. Laminates can include synthetic resin-impregnated or coated base materials composed of successive layers of material, bonded together via heat, pressure, and/or adhesive. Laminates also includes security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy.

Core layers for identification documents can include many different types of materials, including but not limited to resins, polyesters, polycarbonates, vinyls, acrylates, urethanes, and cellulose based materials, thermosetting material, thermoplastic, polymer, copolymer, polycarbonate, fused polycarbonate, polyester, amorphous polyester, polyolefin, silicon-filled polyolefin, TESLIN, TYVEC, plastic paper, paper, synthetic paper, foamed polypropylene film, polyvinyl chloride, polyethylene, thermoplastic resins, engineering thermoplastic, polyurethane, polyamide, polystyrene, expanded polypropylene, polypropylene, acrylonitrile butadiene styrene (ABS), ABS/PC, high impact polystyrene, polyethylene terephthalate (PET), PET-G, PET-F, polybutylene terephthalate PBT), acetal copolymer (POM), polyetherimide (PEI), polyacrylate, poly(4-vinylpyridine, poly(vinyl acetate), polyacrylonitrile, polymeric liquid crystal resin, polysulfone, polyether nitride, and polycaprolactone.

In many typical identification document structures, the core layer is non-transparent and can be laminated with substantially transparent materials. Some types of identification documents do have transparent cores, however, especially those that are laser engraved or etched. Both types of cores are intended to be within the invention. Virtually any material that is capable of withstanding the lamination conditions described herein, and which is capable of being fused to the laminate layers described herein, is usable as a core for at least some embodiments of the invention.

For so-called central issue type systems in which information is printed on a core layer, the core layer will preferably be made of a material capable of being imaged by the chosen printing technology. We have found that printable materials such as silica filled polyolefin (e.g., TESLIN), polycarbonate, PVC, polyester, and various synthetic paper materials work well with at least some embodiments of the invention.

For purposes of illustration, the following description will proceed with reference to ID document structures. It should be appreciated, however, that the present invention is not so limited. Indeed, as those skilled in the art will appreciate, the invention can be applicable to any article of manufacture or document where it is desirable to laminate overlaminate materials over another layer of material.

Description of the Figures

As we have described above, one weakness with some types of known identification documents is intrusion into the identification document. Intrusion can be attempted in many different ways—through application of heat or solvents, by manual peeling, etc. In some known identification documents, adhesives have been used to join two dissimilar materials, such as TESLIN and polycarbonate (PC). Such an adhesive layer between two adjacent identification document layers can be a so-called “weak” point that may enable an intrusion into an identification document that may be harder to detect, especially if the adhesive fails in such a way that information on either the laminate or core layer can be altered without detection.

In contrast, lamination of two similar materials, such as PC to PC, can be effected by heat and pressure alone (or other known lamination methods). This can greatly increase the strength of the resultant structure, as will be appreciated by those skilled in the art.

We have found, surprisingly, systems, processes, and resultant card architectures for press-laminating two relatively dissimilar card materials such that the two materials are joined in a bond significantly stronger than if the two materials had been joined by other methods, such as by adhesives. In one advantageous embodiment, we have applied our inventive systems, processes, and card architectures to joining polycarbonate and TESLIN—without need for an adhesive. TESLIN and polycarbonate joined in this manner provide an identification document that very resistant to tampering.

In addition, we have also found that the systems, processes, and resultant card architectures we describe herein can work with many different types of printing onto the identification documents (without damaging the printing) including (but not limited to) Laser Xerography/electrophotography (e.g., Xerox Docu-color 2240, Xerox Doc 12), laser printers, dye sublimation printing, Indigo printing, Inkjet printing, D2T2 printing, offset printing, and laser engraving, marking, and etching.

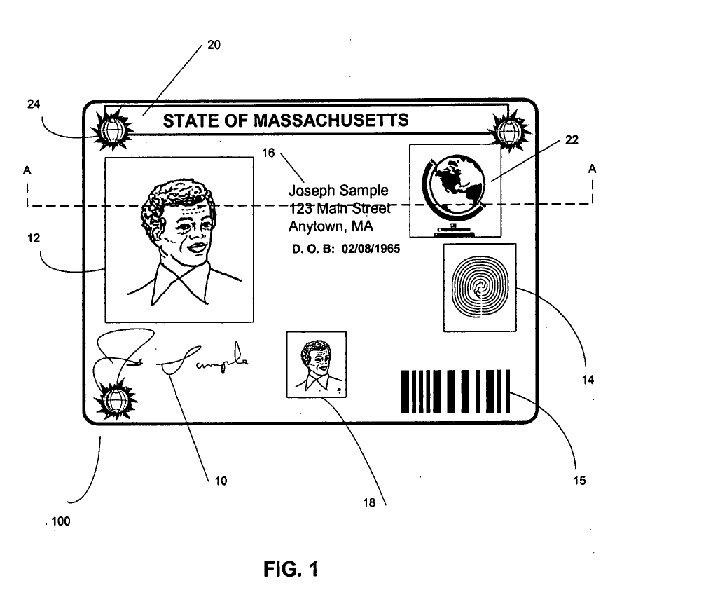

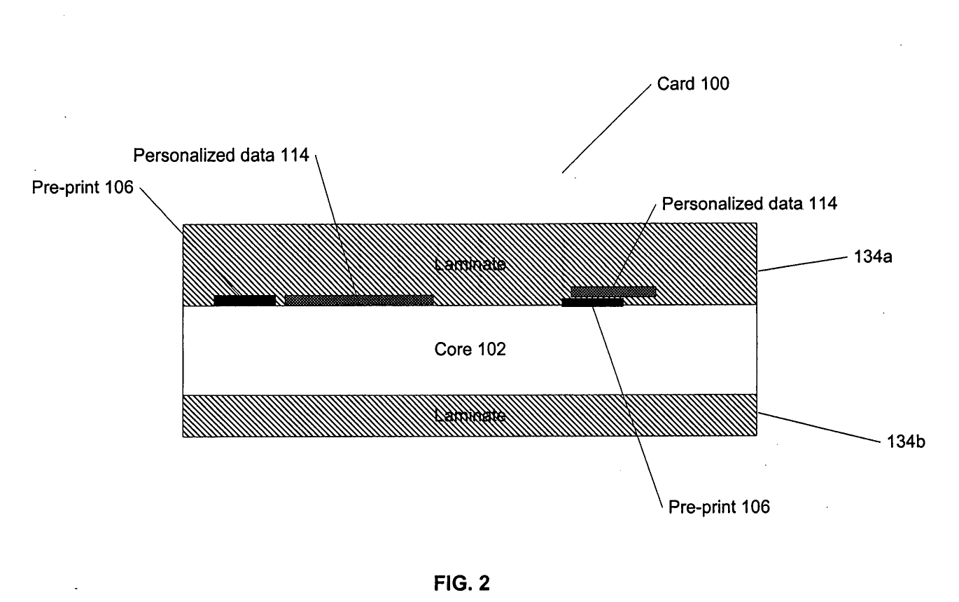

FIG. 1 is an illustration of an identification document 100 in accordance with a first embodiment of the invention, and FIG. 2 is a cross section of the identification document of FIG. 1, taken along the A-A line. Referring to FIG. 1, the exemplary identification document 100 (“ID document 100”) of FIG. 1 includes a signature 10, bearer image 12, biometric information 14, a bar code 15, a so-called “ghost” image 18, an indicator of the issuing body 20, a graphical seal image 22, and a repeating pattern 24 (which is part of the laminate layer 134, described further below). In the example ID document 100, the signature 10, bearer image 12, biometric information 14, and bar code 15 are all so-called “variable” data. The indicator of the issuing body 20 and graphical seal image 22 are so-called “fixed” data. Of course, those skilled in the art will appreciate that all of the elements of the ID document 100 are not required for the invention, and that many others (e.g., a magnetic strip signature strip, covert image, hologram, fine line printing, etc.) could also be included. FIG. 1 is intended to be merely illustrative of the general types of items that an ID document 100 can contain, but is not, of course, exhaustive.

Referring to FIG. 2, in accordance with a first embodiment of the invention, the ID document 100 includes a core layer 102 sandwiched between first and second laminate layers 134a, 134b. Fixed indicia (also referred to herein as pre-print) 106 and personalized data are printed to the core 102 by any known method, and the laminate is applied over the printed information. The laminate itself may include one or more security features or patterns, such as the repeating security pattern 24 shown in FIG. 1 (but not visible in FIG. 2). Although printing is shown only on the “top” side of the core 102, printing can of course occur on the “bottom” side, if desired. In addition, as those skilled in the art will appreciate, some or all of the printed information (fixed and variable indicia) could instead be printed in reverse on one side of the laminate 134a prior to affixing the laminate 134a to the core 102.

In one embodiment, the core layer is TESLIN, having a thickness of about 10 to 14 mils thick, and the laminate layers 134a, 134b each comprise substantially transparent polycarbonate about 5-10 mils thick. We have found that other core materials are usable as long as the core materials are compatible with the material used for the laminate layers 134a, 134b. For example, in one embodiment, we have used opaque polycarbonate, about 10-14 mils thick, in combination with substantially transparent polycarbonate laminate layers 134a, 134b that are about 5-10 mils thick. We also anticipate that many other combinations of core materials and laminate materials would work if they are compatible and amenable to the laminating process described herein. For example, we anticipate that our process can be readily adapted to use materials such as polyvinyl chloride (PVC), polystyrene, polypropylene, and polyesters, among many others, especially in embodiments where the core 102 and laminate layers 134a, 134b each comprise materials similar to and/or compatible with the other.

Many different polycarbonates are usable for the core 102 and/or laminate layers 134a, 134b of the invention. We have achieved good results using polycarbonates such as LEXAN 8A13-112 (available from General Electric Plastics of Pittsfield, Mass.) and Bayer Makrofol DPF 5005 polycarbonate (available from Bayer Polymers of Pittsburgh, Pa.).

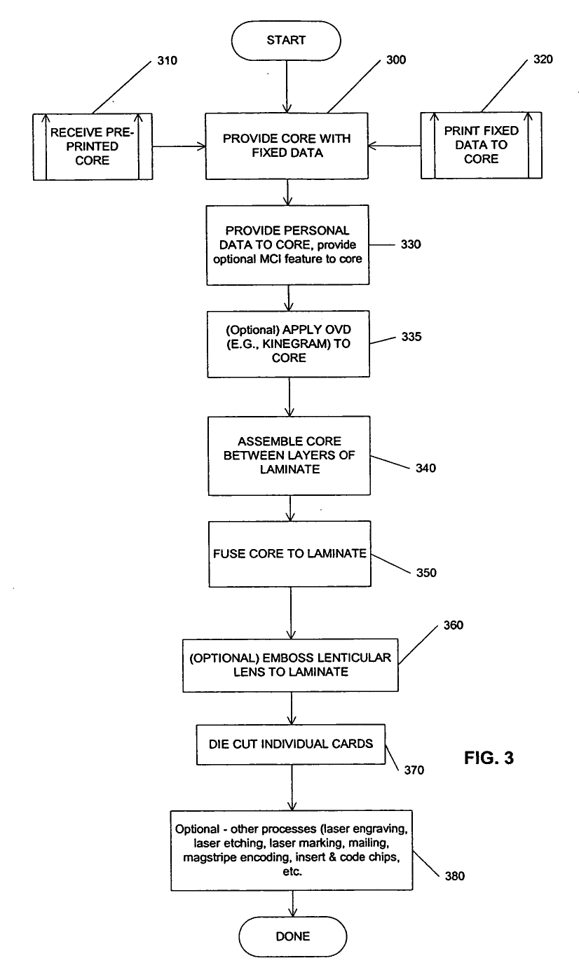

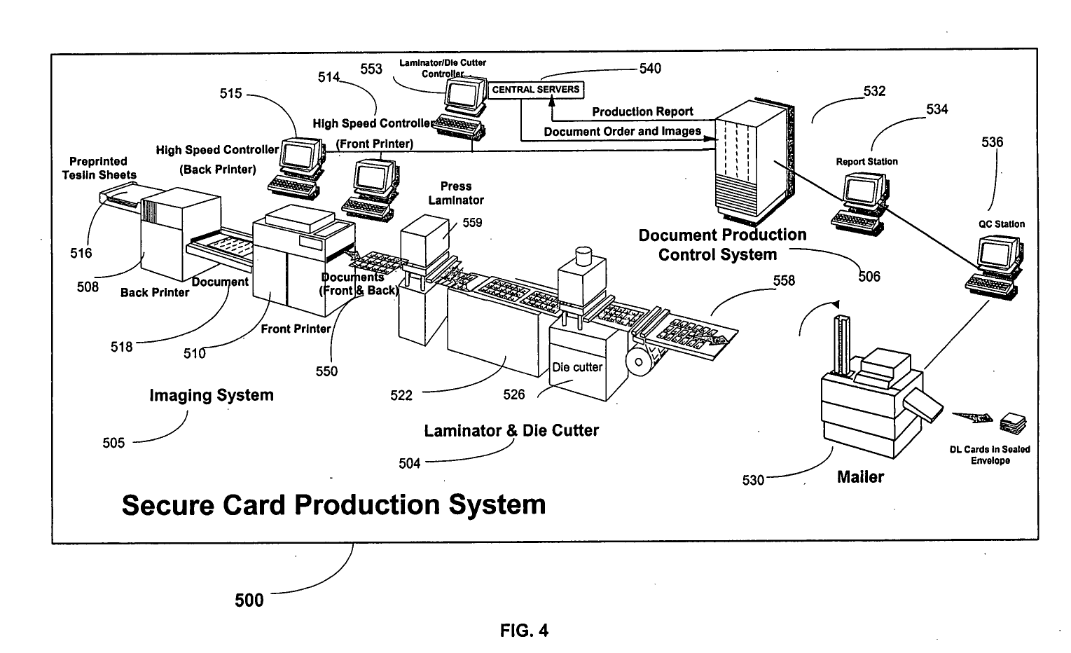

FIG. 3 is a flow chart of a first process for manufacturing identification cards, in accordance with one embodiment of the invention, and FIG. 4 is an illustrative diagram of a central issue card production system that can be used to implement the process of FIG. 3 to produce the identification documents in accordance with at least some embodiments of the invention. Referring to FIGS. 2, 3, and 4, the core 102 is provided with fixed data 106 (step 300) and other non-variable images in the form of pre-printed sheets, such as the pre-printed TESLIN sheets 516 of FIG. 4. The printed sheets each contain an array of a plurality of card blanks, which can be printed to and then separated.

The fixed data 106 can be pre-printed to the core (step 310) by any known method, including, for example, offset printing or lithography printing. The pre-printed information 106 can include, for example, the so-called “fixed” data described above, as well as indicia such as security-features, e.g., specific colors, microprinting, security indicia, security patterns, etc. The security pattern can be applied in an ordered arrangement having a tightly-printed pattern, i.e., having a plurality of finely-divided printed and unprinted areas in close proximity to one another. A tightly-printed pattern may, for example, appear as an often-repeated logo or design or a fine-line printed security pattern such is used in the printing of banknote paper, stock certificates and like and may take the form of filigree, guilloche or other fine-line printing. U.S. Pat. No. 4,653,775 provides an example of such security printing and is hereby incorporated by reference. Alternately, a printer (not shown in FIG. 4) can be provided to print the fixed data 106 to the core 102 (step 320). The fixed data 106 can also be printed at substantially the same time as the variable data 114 and can, if desired, be printed using the same printing technique used to print the variable data 114.

Variable/personalized data 114 is printed to the core 102 (step 330). In the example secure card production system 500 of FIG. 4, a back printer 508 prints the back side of the cards first, then a front printer 510 prints to the cards. Of course, the order of printing is not important, and the system 500 could instead employ printers that print both sides at substantially the same time. Many different types of printing are usable, in accordance with the invention, to print personalized data 114 to the core 102, including (but not limited to) Laser Xerography/electrophotography (e.g., Xerox Docu-color 2240, Xerox Doc 12), laser printers, dye sublimation printing, Indigo printing, D2T2 printing, offset printing, and inkjet printing, specially ultraviolet (UV) curable inkjet printing, which has a suitable printing speed and can reduce image distortion during production of the identification document 100. Methods to form information that do not require printing media, such as laser engraving, laser marking, and laser etching, also are usable, whether alone or in combination with “printing media” type printing, but generally methods such as laser engraving, laser marking, and laser etching are employed after lamination of the laminate 134a, 134b, to the core 102.

An optional part of the step of printing personal data 330 could, if desired, include forming a multiple image feature such as described in the commonly assigned patent application entitled “Multiple Image Security Features for Identification Documents and Methods of Making Same”, Ser. No. 10/325,434, published as U.S. patent publication No. 20030183695 on Oct. 2, 2003, which we incorporate by reference. We expressly contemplate combining the teachings of that patent application with the teachings of the instant application.

Another optional step includes applying an optically variable device, such as a KINEGRAM, EXELGRAM, hologram, etc. to the core 102 (step 335). This step can occur before or after the personalization step 330, although in some instances it may be preferable to apply certain optical variable devices, such as KINEGRAMS, prior to personalization if the personalized data is intended to wholly or partially overlay the optically variable device. Applications of using KINEGRAMS with identification documents are described further in two commonly assigned patent applications, entitled “Optically Variable Devices with Embedded Data for Authentication of Identification Documents” (Application No. 60/459,284, filed Mar. 31, 2003), and “Optically Variable Devices with Encrypted Embedded Data for Authentication of Identification Documents” (Application No. 60/463,659, filed Apr. 16, 2003). The contents of both of these applications are incorporated by reference, and we expressly contemplate combination of the teachings of either or both of these patent applications with the instant patent application.

After the desired printing and/or other features are provided to the core 20, the core 102 is positioned and assembled (step 340) between the laminate layers 134a, 134b, for lamination using a press laminator (step 350). The press laminator 559 includes a platen-type press, with polished steel plates that are positioned outside of the “sandwich” of laminate layers 134a, 134b and core 102. With at least some types of press laminators 559, it can be possible to accomplish a plurality of laminations at once—e.g. multiple “sandwiches”, each separated by a lamination—resistant layer, such as a sheet of metal. In that way, more than one sheet of identification documents can be processed at once.

We have achieved good lamination results for fusing TESLIN to polycarbonate using a lamination temperature between 310 and 350 degrees F. and a pressure range from 5000-15,000 pounds per square meter (PSM), for about 5-10 minutes, using the Model MTP1404 Compressor Laminator from Tetrahedron Associates of San Diego, Calif. In at least one advantageous embodiment, we used a lamination temperature of about 340 degrees F., a pressure of about 10,000 PSM, and a lamination time of about 7 minutes to fuse together a TESLIN core between two layers of PC. The fusing achieved under these conditions advantageously achieved an identification document 100 in which the TESLIN and the PC did not separate from each other when intrusion was attempted; instead (as further described herein), the TESLIN itself irreversibly split.

As those skilled in the art will recognize, the particular temperatures, pressures, and times will vary depending on both the materials used and the type of printing that is used. Temperatures that are too high can cause damage (e.g., cracking) to some materials, such as TESLIN. Further, certain types of printing can become distorted or otherwise damaged under certain laminating conditions. We have found, however, that printing such as laser xerography using a Xerox 2240 printing survives a lamination process of 340 degrees F., a pressure of about 10,000 PSM, and a lamination time of about 7 minutes, without losing any significant resolution. Under these same conditions, we have also found good results using (a) information printed on TESLIN by an EPSON 2200 pigmented ink jet printer; (b) information printed on PC using a UV cured ink jet printer; (c) and/or information printed on PC using a solvent ink jet printer.

Of course, many other types of laminators would be usable. In addition, although many advantageous embodiments of the invention can be implemented using a press-type laminator as described herein, other types of laminators (e.g., roll-laminators, pouch laminators, etc.) may also be used if these laminators can achieve the conditions necessary to fuse the laminate layers 134a, 134b to the core layer 102.

In one embodiment, an important element of successful lamination is providing a lack of shear at the interfaces between the laminate layers 134a, 134b and the core 102. This can be especially important when the information is printed to the core 102 by laser xerography.

Referring again to FIG. 3, after the lamination (step 350), if an optional multiple color image feature was provided in step 330, an optional lenticular lens can be embossed the laminate (step 360). More information about the embossing step (and illustrations of illustrative embossing systems, methods, and devices) can be found in the aforementioned and incorporated-by-reference “Multiple Image Security Features for Identification Documents and Methods of Making Same” patent application. Of course, the systems, methods, and devices for embossing a lenticular lens are not limited to those described in that patent application; those skilled in the art will realize that many different techniques are usable for forming lenticular lenses and/or multiple image features. In addition, as explained further in that patent application, instead of embossing the lenticular lens into the laminate after the identification document is assembled, lenses that have already been formed/embossed into the laminate (e.g., in a registered fashion) can be incorporated, in which case the embossing step 360 may not be needed.

After optional step 360, the identification documents are separated into individual documents, such as by die cutting (step 370). The identification documents 100 are then ready for additional optional processes, such as laser engraving, laser etching, laser marking, encoding of magnetic stripes and/or bar codes, insertion and/or programming of computer chips, writing to media (such as LASERCARD optical media, available from Drexler/LaserCard), quality checking, inspection, mailing, etc. Note also that some of these additional processes can be accomplished prior to die cutting (step 370).

Although the system and method of FIGS. 3 and 4 illustrate one type of a central-issue manufacturing process for making identification documents, in accordance with at least some embodiments of the invention, those skilled in the art will readily perceive how this process can be adapted to other central issue and/or large scale identification document manufacturing systems, as well as for “on the spot” or so-called “over the counter” identification card manufacturing.

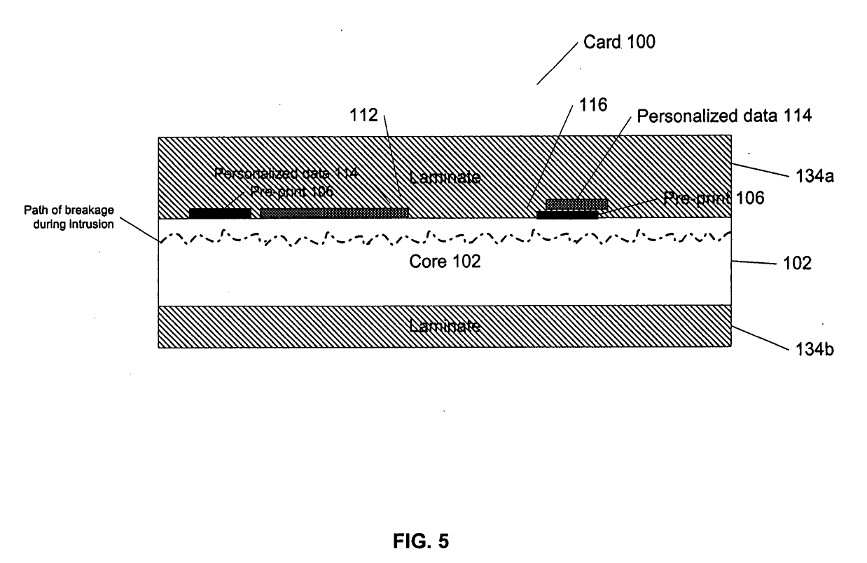

With the inventive press lamination described herein (including the inventive fusing of TESLIN and PC described herein), intrusion attempts even at 300 degrees Fahrenheit (F) can split all or part of the TESLIN cores. Further, we have found that, after applying the inventive methods described herein, our attempts to split the TESLIN from the PC yielded a substantially complete splitting of the TESLIN core. The attempted intrusions, and the results of such attempted intrusions, are illustrated in FIGS. 5 through 8. FIG. 5 shows the path of breakage during an attempted intrusion into the identification card of FIG. 1, where the particular embodiment of the card is manufactured using TESLIN for the core 102 and polycarbonate for the laminate layers 134a, 134b. The attempted intrusion in this example is a heating of the identification document combined with a manual attempt to “peel back” the top laminate layer 134a.

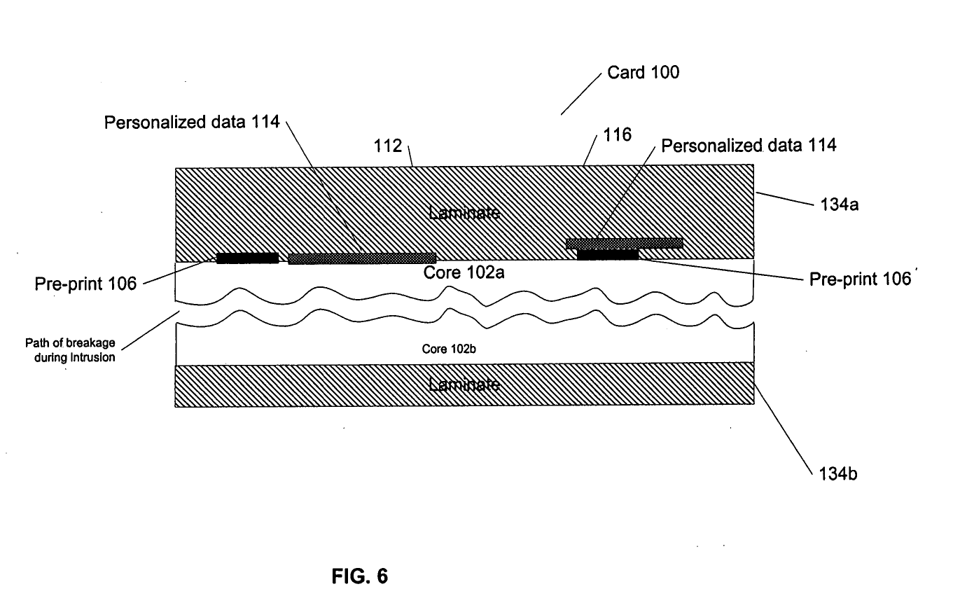

FIG. 6 illustrates one type of actual breakage of the core 102 that can occur with such an intrusion, in accordance with one embodiment of the invention. As FIG. 6 illustrates, the core 102 of FIG. 1 has split into two sub parts, core 102a and core 102b. The printing on the original core 102 has remained with core 102a and laminate layer 134a. The splitting of the core 102, whether complete (as shown in FIG. 6) or partial (not shown) effectively destroys the identification document 100. In at least some instances this splitting can absolutely prevent the reassembly of the identification document 100 because TESLIN will be on both sides of the split surfaces and cannot be made to rejoin under any combination of pressure and temperature. Use of another means of attaching, such as adhesive, will be detectable.

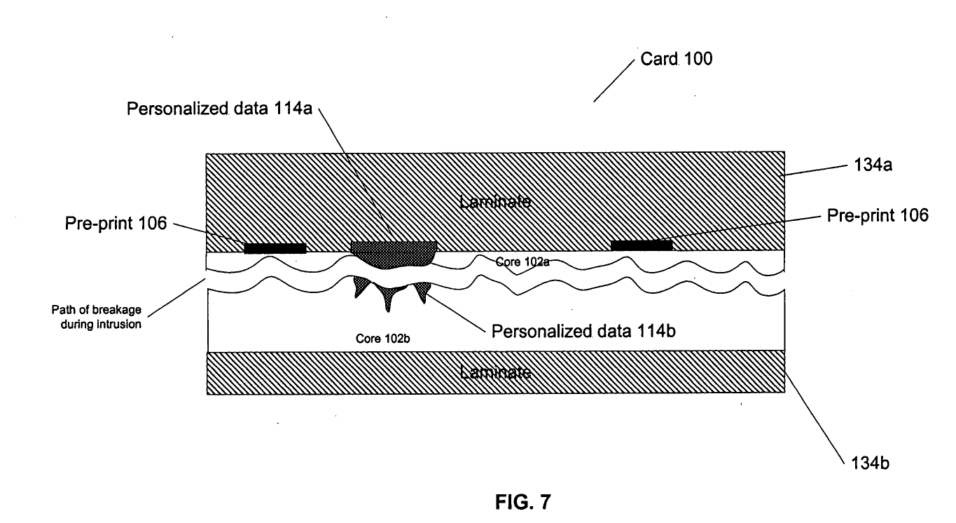

FIG. 7 illustrates another type of actual breakage of the core 102 that can occur with an intrusion by heat and peeling, in accordance with one embodiment of the invention. In FIG. 7, the core 102 is TESLIN and the type of printing used to print the personalized data 114 was inkjet printing using an aqueous inkjet ink, which printing is further described in a commonly assigned patent application entitled “Identification Card Printed With Jet Inks and Systems and Methods of Making Same”, Ser. No. 10/289,962, filed Nov. 6, 2002 and published as publication No. 20030211296 on Nov. 13, 2003, the contents of which are incorporated by reference. As this referenced patent application shows, aqueous ink jet ink can flow into the micropores of the TESLIN (which feature is also illustrated in FIG. 7). Thus, upon breakage or splitting of a core 102 made of TESLIN, part of a given piece of personalized data 114a may stay with one portion of the core 102a, while the rest of the given piece of personalized data 114b goes with the other part of the core 102b. This breakage of both core 102 and personalized data 114 can make the identification document 100 even more resistant to tampering and can help ensure that attempted and/or actual alterations are visually detectable.

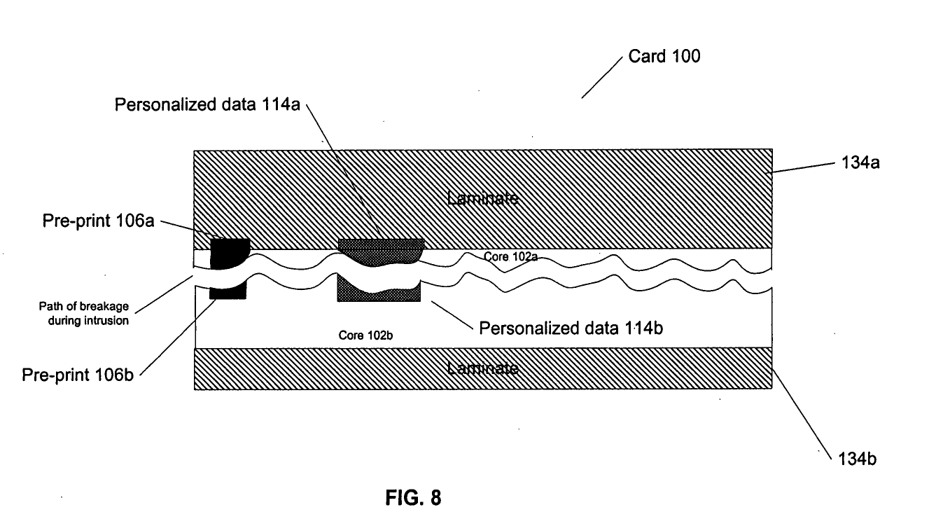

FIG. 8 illustrates still another type of actual breakage of the core 102 and personalized (and pre-print) data that can occur from an intrusion by heat and peeling, in accordance with one embodiment of the invention. In this example, the path of breakage includes breaks in both the pre printed information 106 and the personalized data 114. This type of breakage may occur, for example, with printing (either pre-printing 106 and/or personalized printing 114) that has strong adhesion to the laminate layer 134. For example, laser xerographic printing has good adhesion to polycarbonate, so the breakage illustrated in FIG. 8 can occur when the personalized printing 114 and/or the pre-printed or fixed information 106 is printed via laser xerography.

For the examples of FIGS. 5-8 (and for other types of splitting), even if the pattern of splitting leaves an area of relative “bare” polycarbonate (which the tampering individual would attempt to re-attach to the TESLIN core), the pressures and temperatures necessary to accomplish this are very difficult to achieve and, preferable, would be available only with large, expensive, commercial/industrial style presses.

We expressly contemplate that at least some embodiments of the invention can further be used with cohesively failing inks, such as those described in a commonly assigned patent application entitled “Ink with Cohesive Failure and Identification Document Including Same”, Ser. No. 10/329,315, published as publication No. 20030226897 on Dec. 11, 2003. The contents of this patent application are hereby incorporated by reference.

Of course, in embodiments of the invention where the core 102 and laminate layers 134a, 134b are made of the same material (e.g., PC, PVC, polystyrene, polyethylene terephthalate (PET), polyester, polypropylene, etc.), the resultant laminated structures cannot be separated with heat even allowing for destruction of any interlayers. The same holds true for any “pure polymer” identification document—because all layers of the identification document are constructed of the same material, each layer melts at the same point, rendering attempts to separate layers essentially useless.

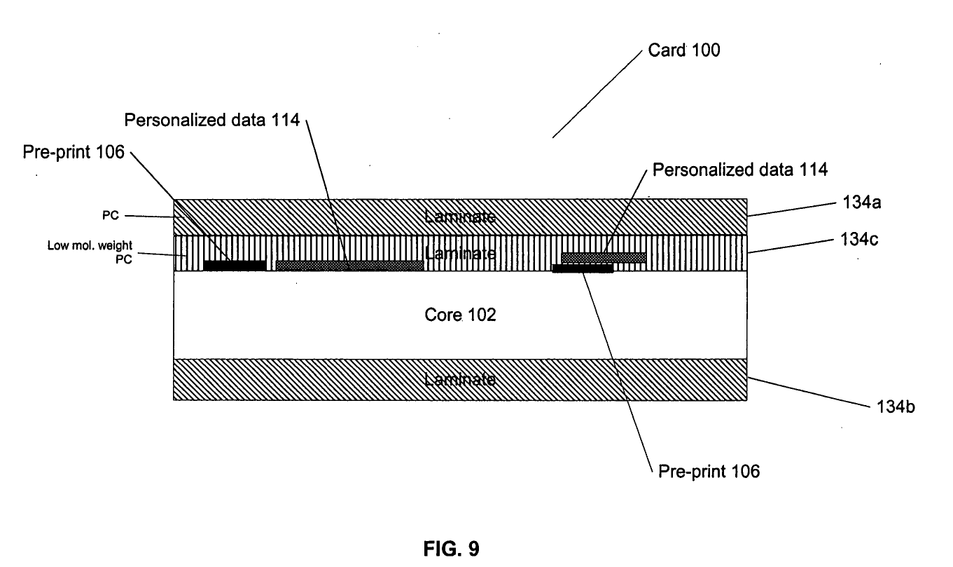

It is, of course, possible to construct the identification document 100 such that the top laminate layer 134a is made of a different material than the bottom laminate layer 134b. In addition, although two layers 134a, 134b of PC are shown in FIG. 2, two layers are not required. The laminate layers 134a, 134b layers can be either one layer or two or more per side dependent upon the functionality desired. For example, in one embodiment, as shown in FIG. 9, there can be two laminate layers 134a, 134c on one or both sides of the core 102. In one embodiment, as shown in FIG. 9, a low molecular weight (LMW) laminate layer 134c, made from LMW PC, is disposed directly adjacent the core 102. The LMW laminate layer 134c is a lower molecular weight than the outermost layer 134a (which, in this example is also polycarbonate). We have found that using a low molecular weight polyester, in some instances, can permit the manufacturing process to use a less demanding heat and pressure lamination to seal the low molecular weight laminate to the core 102, while at the same time, allowing the higher molecular weight (MW) laminate layer 134a to protect the contents of the system by being located on the outside of the identification document 100. The architecture of FIG. 9 works even for cores 102 made using TESLIN.

Embodiments of the invention can also be adapted to work with identification documents that are personalized (and/or pre-printed) using laser engraving. Processes for laser engraving of identification documents, including additives for making certain materials more receptive to laser engraving, are described in a commonly assigned application entitled “Laser Engraving Methods and Compositions, and Articles Having Laser Engraving Thereon”, Ser. No. 10/326,886, filed Dec. 20, 2002 and published as publication No. 2003/0234286 on Dec. 25, 2003, and the contents of this application are incorporated by reference. We expressly contemplate combining the teachings of this commonly assigned that patent application with the teachings of the instant application.

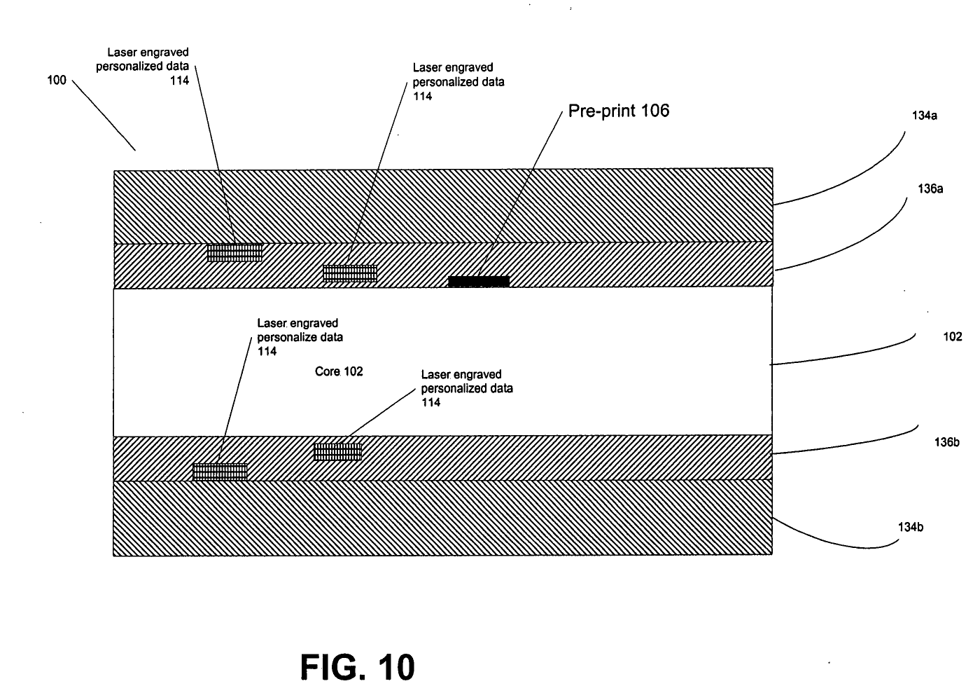

For example, FIG. 10 is a cross sectional of an identification document 100 in accordance with an embodiment of the invention, showing personalized data 114 formed by laser engraving. In the identification document 100 of FIG. 10, one or more laser sensitized laminate layers 136a, 136b (e.g., layers that are responsive to laser engraving, such as by having had mixed into them a laser sensitizing additive such as the inventive laser enhancing additive of the Ser. No. 10/326,886 application) are disposed adjacent to the core 102. One or more non-sensitized laminate layer 134a, 134b are disposed on the “outer” side of the identification document. This arrangement can provide advantages such as a reduction in cost and a concentration of the engraved pixels at an interface close to the core 102. Of course, it is not necessary to include both sensitized and non-sensitized laminate layers—the single layer of laminate 134a, 134b can consist of sensitized material. In addition, the identification document 100 of FIG. 10 could be implemented using a single sensitized laminate layer 134a on the “front” and a single non-sensitized laminate layer 134b on the “back” (and vice versa).

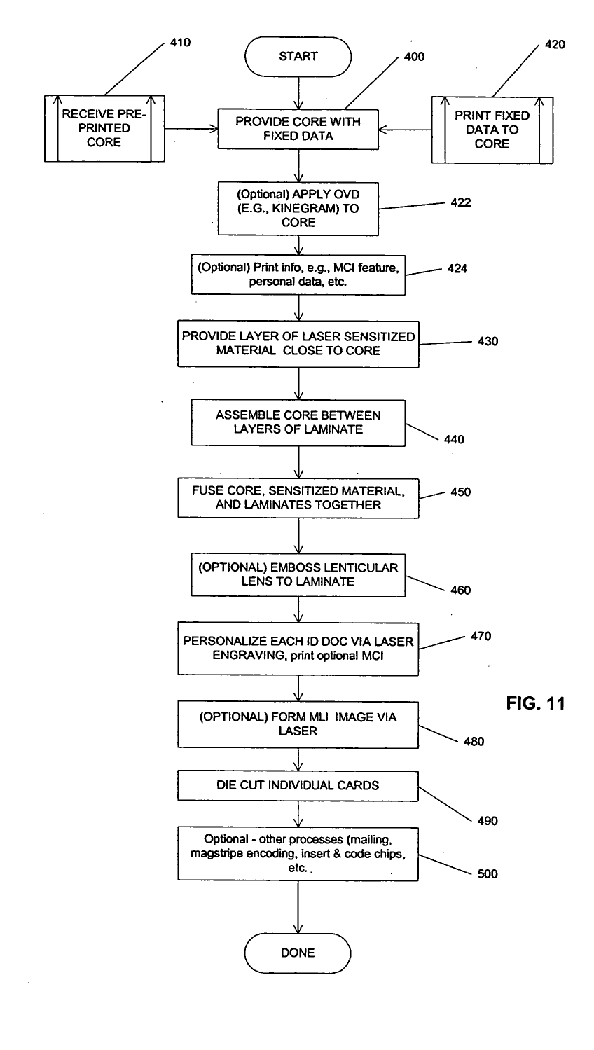

FIG. 11 is a flow chart of a method that can be used to laser engrave the identification document 100 of FIG. 10. Many of the steps of FIG. 11 are substantially similar to some of the steps in FIG. 3 and the explanations for the same or similar steps are not repeated here. In optional step 424, information can be printed to the core in addition to the later laser engraving of step 470. The printing can, for example, include printing a multiple color image (MCI) feature (which is used with the aforementioned lenticular lens and associated related patent application); however, the multiple color image can also be formed by laser engraving (whether in gray scale or color).

Step 408 includes a step of forming a so-called “multiple laser image” (MLI) via laser engraving. In at least one embodiment, MLI uses a laser such as a diode pumped YAG lasers to write multiple images at different angles into a layer of laminate. More information about multiple laser images can be found, for example, in U.S. Pat. No. 4,765,565, pending German patent application DE4441198, pending German patent application DE19530495, pending German patent application DE19647153, and pending German patent application DE 19647145. The contents of all of these pending and issued patent documents are hereby incorporated by reference..

Digital Watermarking Combined with Invention

In at least some embodiments of the invention, as part of the printing and or laser engraving of personalized information to the identification document, we embed a steganographic code into some or all of the personalized data 114. For example, steganographic code can be embedded into the bearer image 12 (FIG. 1). The code can be embedded in the master image (e.g., photograph of the bearer), or the code can be embedded in perceptually significant features, e.g., facial outlines, hair, etc. that are able to survive the processing described herein.

One form of steganographic encoding is digital watermarking. Digital watermarking is a process for modifying physical or electronic media to embed a machine-readable code into the media. The media may be modified such that the embedded code is imperceptible or nearly imperceptible to the user, yet may be detected through an automated detection process. In some embodiments, the identification document includes two or more digital watermarks.

Digital watermarking systems typically have two primary components: an encoder that embeds the digital watermark in a host media signal, and a decoder that detects and reads the embedded digital watermark from a signal suspected of containing a digital watermark (a suspect signal). The encoder embeds a digital watermark by altering the host media signal. The reading component analyzes a suspect signal to detect whether a digital watermark is present. In applications where the digital watermark encodes information, the reader extracts this information from the detected digital watermark. The reading component can be hosted on a wide variety of tethered or wireless reader devices, from conventional PC-connected cameras and computers to fully mobile readers with built-in displays. By imaging a watermarked surface of the card, the watermark's “payload” can be read and decoded by this reader.

Several particular digital watermarking techniques have been developed. The reader is presumed to be familiar with the literature in this field. Some techniques for embedding and detecting imperceptible watermarks in media signals are detailed in the assignee's co-pending U.S. patent application Ser. No. 09/503,881, U.S. Pat. No. 6,122,403 and PCT patent application PCT/US02/20832, which are each herein incorporated by reference.

In one embodiment, the watermark embedded in the bearer image 12 may include a payload or message. The message may correspond, e.g., to the ID document number, printed information, issuing authority, biometric information of the bearer, and/or database record, etc. The watermark embedded in the bearer image 12 may also include an orientation component, to help resolve image distortion such as rotation, scaling and translation. In at least one embodiment of the invention, we further can embed two or more watermarks in the bearer image 12 or even in an OVD (e.g., KINEGRAM) applied to the identification document 100.

In further embodiments, the watermark embedded in the bearer image 12 can correspond to information printed on the ID document, or to information carried by a second watermark embedded elsewhere on the ID document (e.g., in a background pattern, bar code 15, etc.). More techniques for digital watermarks and ID cards can be found in Digimarc's U.S. Provisional Patent application No. 60/421,254, U.S. patent application Ser. No. 10/094,593, and in U.S. Pat. No. 5,841,886. Each of these patent documents is incorporated herein by reference. We expressly contemplate that the techniques disclosed in this application can be combined with the aspects of the present invention.

Concluding Remarks

Having described and illustrated the principles of the technology with reference to specific implementations, it will be recognized that the technology can be implemented in many other, different, forms, and in many different environments.

The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

It should be appreciated that while FIG. 1 illustrates a particular species of ID document—a driver's license—the present invention is not so limited. Indeed our inventive methods and techniques apply generally to all identification documents defined above. Moreover, our techniques are applicable to non-ID documents, e.g., such as printing or forming covert images on physical objects, holograms, etc., etc. Further, instead of ID documents, the inventive techniques can be employed with product tags, product packaging, business cards, bags, charts, maps, labels, etc., etc., particularly those items including providing a non-visible indicia, such as an image information on an over-laminate structure. The term ID document is broadly defined herein to include these tags, labels, packaging, cards, etc. In addition, while some of the examples above are disclosed with specific core components, it is noted that-laminates can be sensitized for use with other core components. For example, it is contemplated that aspects of the invention may have applicability for articles and devices such as compact disks, consumer products, knobs, keyboards, electronic components, decorative or ornamental articles, promotional items, currency, bank notes, checks, etc., or any other suitable items or articles that may record information, images, and/or other data, which may be associated with a function and/or an object or other entity to be identified.

It should be appreciated that the methods described above with respect to FIGS. 3, 4, and 11 (including the control systems shown in FIG. 4) as well as the methods for implementing and embedding digital watermarks, can be carried out on a general-purpose computer. These methods can, of course, be implemented using software, hardware, or a combination of hardware and software. Systems and methods in accordance with the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems. Computer executable software embodying the FIG. 2 and/or FIG. 11 steps, or a subset of the steps, can be stored on a computer readable media, such as a diskette, removable media, DVD, CD, hard drive, electronic memory circuit, etc.).

It should be understood that, in the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

To provide a comprehensive disclosure without unduly lengthening the specification, applicants hereby incorporate by reference each of the U.S. patent documents referenced herein.

The technology and solutions disclosed herein have made use of elements and techniques known from the cited documents. Other elements and techniques from the cited documents can similarly be combined to yield further implementations within the scope of the present invention. Thus, for example, single-bit watermarking can be substituted for multi-bit watermarking, technology described as using imperceptible watermarks or encoding can alternatively be practiced using visible watermarks (glyphs, etc.) or other encoding, local scaling of watermark energy can be provided to enhance watermark signal-to-noise ratio without increasing human perceptibility, various filtering operations can be employed to serve the functions explained in the prior art, watermarks can include subliminal graticules to aid in image re-registration, encoding may proceed at the granularity of a single pixel (or DCT coefficient), or may similarly treat adjoining groups of pixels (or DCT coefficients), the encoding can be optimized to withstand expected forms of content corruption, etc.

Thus, the exemplary embodiments are only selected samples of the solutions available by combining the teachings referenced above. The other solutions necessarily are not exhaustively described herein, but are fairly within the understanding of an artisan given the foregoing disclosure and familiarity with the cited art. The particular combinations of elements and features in the above-detailed embodiments are exemplary only; the interchanging and substitution of these teachings with other teachings in this and the incorporated-by-reference patent documents are also expressly contemplated.

In describing the embodiments of the invention illustrated in the figures, specific terminology is used for the sake of clarity. However, the invention is not limited to the specific terms so selected, and each specific term at least includes all technical and functional equivalents that operate in a similar manner to accomplish a similar purpose.

1. An identification document, comprising:
a core layer having at least one indicium formed thereon, the core layer having a first surface; and
a first layer of laminate affixed to the core layer by a press lamination process and without use of an adhesive, where the press lamination process is sufficient to couple the core layer to the first layer such that an attempt to separate the first layer from the core layer causes at least a partial destruction of the core layer.

2. The identification document of claim 1, wherein the lamination process is sufficient to fuse the first layer of laminate to the core layer.

3. The identification document of claim 1, wherein the core layer comprises at least one of a resin, polyester, polycarbonate, vinyl, acrylate, urethane, and cellulose based materials, thermosetting material, thermoplastic, polymer, copolymer, polycarbonate, fused polycarbonate, polyester, amorphous polyester, polyolefin, silicon-filled polyolefin, TESLIN, TYVEC, plastic paper, paper, synthetic paper, foamed polypropylene film, polyvinyl chloride, polyethylene, thermoplastic resins, engineering thermoplastic, polyurethane, polyamide, polystyrene, expanded polypropylene, polypropylene, acrylonitrile butadiene styrene (ABS), ABS/PC, high impact polystyrene, polyethylene terephthalate (PET), PET-G, PET-F, polybutylene terephthalate PBT), acetal copolymer (POM), polyetherimide (PEI), polyacrylate, poly(4-vinylpyridine, poly(vinyl acetate), polyacrylonitrile, polymeric liquid crystal resin, polysulfone, polyether nitride, and polycaprolactone.

4. The identification document of claim 1, wherein the first layer of laminate comprises at least one of a resin, polyester, polycarbonate, vinyl, acrylate, urethane, and cellulose based materials, thermosetting material, thermoplastic, polymer, copolymer, polycarbonate, fused polycarbonate, polyester, amorphous polyester, polyolefin, silicon-filled polyolefin, TESLIN, TYVEC, plastic paper, paper, synthetic paper, foamed polypropylene film, polyvinyl chloride, polyethylene, thermoplastic resins, engineering thermoplastic, polyurethane, polyamide, polystyrene, expanded polypropylene, polypropylene, acrylonitrile butadiene styrene (ABS), ABS/PC, high impact polystyrene, polyethylene terephthalate (PET), PET-G, PET-F, polybutylene terephthalate PBT), acetal copolymer (POM), polyetherimide (PEI), polyacrylate, poly(4-vinylpyridine, poly(vinyl acetate), polyacrylonitrile, polymeric liquid crystal resin, polysulfone, polyether nitride, and polycaprolactone.

5. The identification document of claim 1, wherein the core layer comprises silica filled polyolefin and the laminate layer comprises polycarbonate.

6. The identification document of claim 1, wherein the core layer and the laminate layer each comprise polycarbonate.

7. The identification document of claim 1, wherein at least one of the laminate layer and the core layer further comprises a laser sensitizing material.

8. The identification document of claim 7, wherein the laser sensitizing material comprises copper potassium iodide, copper iodide, zinc sulfide, barium sulfide, alkyl sulfonate, or thioester.

9. The identification document of claim 1, wherein the core layer is laminated to the first layer of laminate by a press lamination process wherein the a lamination temperature is between 310 and 350 degrees F., the lamination pressure is between 5000-15,000 pounds per square meter (PSM), and the lamination time is between 5-10 minutes.

10. The identification document of claim 1, wherein the lamination temperature is about 340 degrees F., the pressure is about 10,000 PSM, and the lamination time is about 7 minutes.

11. The identification document of claim 1, further comprising a second laminate layer disposed between the first laminate layer and the core layer, wherein the second laminate layer has a lower molecular weight than the first laminate layer.

12. The identification document of claim 1, further comprising a third laminate layer disposed between the first laminate layer and the core layer, wherein the third laminate layer further comprises a laser sensitizing material.

13. The identification document of claim 1, wherein the indicium formed on the core layer comprises at least one of fixed and variable data.

14. The identification document of claim 1, wherein the indicium is printed using at least one of Indigo, laser xerography, inkjet, D2T2, offset, lithography, thermal transfer, and laser engraving.

15. A method of manufacturing an identification document, comprising:
providing a core layer;
forming at least one indicium on the core layer; and
affixing a laminate layer to the core layer via a lamination process that is sufficient to couple the core layer to the first layer such that an attempt to separate the first layer from the core layer causes at least a partial destruction of the core layer.

16. The method of claim 15, wherein the core layer comprises silica filled polyolefin.

17. The method of claim 15, wherein the laminate layer comprises polycarbonate.

18. The method of claim 15 where the lamination process comprises a platen press lamination process.

19. The method of claim 15 where the lamination process comprises:
(a) heating the core layer and the laminate layer to a temperature between 310 and 350 degrees F.;
(b) applying a lamination pressure of between 5000-15,000 pounds per square meter (PSM); and
(c) maintaining steps (a) and (b) for time between 5-10 minutes.

20. The method of claim 15 where the lamination process comprises:
(a) heating the core layer and the laminate layer to a temperature of about 340 degrees F.;
(b) applying a lamination pressure of about 10,000 pounds per square meter (PSM); and
(c) maintaining steps (a) and (b) for about 7 minutes.
